(19) United States
(12) Patent Application Publication
(10) Pub. No.: US 2026/0094549 A1
(43) Pub. Date: Apr. 2, 2026

(54) Display Driver And Display Device

(71) Applicant: SEIKO EPSON CORPORATION, Tokyo (JP)

(72) Inventor: Kazuaki TANAKA, Chino (JP)

(21) Appl. No.: 19/342,854

(22) Filed: Sep. 29, 2025

(30) Foreign Application Priority Data
Sep. 30, 2024 (JP) 2024-170137

(51) Int. Cl. G09G 3/00; G09G 3/36

(52) U.S. Cl. CPC G09G 3/006; G09G 3/3648; G09G 2330/025; G09G 2330/12

(57) ABSTRACT

A display driver includes a driver circuit that outputs a drive signal to a display electrode EL of an electro-optical panel, a driver control circuit that controls the driver circuit, and an inspection circuit. The inspection circuit includes a comparison circuit that compares a voltage of the drive signal with a reference voltage, and a determination circuit that determines an abnormality based on an expected value corresponding to a level of the drive signal and a comparison result of the comparison circuit. In a determination mode, the driver control circuit controls a gate of a drive transistor of the driver circuit such that the drive transistor outputs the drive signal at a constant current.

The present application is based on, and claims priority from JP Application Serial Number 2024-170137, filed Sep. 30, 2024, the disclosure of which is hereby incorporated by reference herein in its entirety.

### BACKGROUND

### 1. Technical Field

The present disclosure relates to a display driver, a display device, and the like.

### 2. Related Art

JP-A-2020-106633 discloses a liquid crystal driver that supplies a drive signal to a segment electrode based on a segment signal and compares a monitor signal received from the segment electrode with the segment signal to detect abnormal driving of the segment electrode.

JP-A-2020-106633 is an example of the related art.

It has been found that, when a short circuit of a signal line occurs in an electro-optical panel such as a liquid crystal panel driven by such a liquid crystal driver, there is a problem that an overcurrent flows through a path or a voltage of a monitor signal of a drive signal changes depending on a resistance value of the short-circuited path, and thus determination accuracy deteriorates.

### SUMMARY

An aspect of the present disclosure relates to a display driver including: a driver circuit configured to output a drive signal to a display electrode of an electro-optical panel; a driver control circuit configured to control the driver circuit; and an inspection circuit, in which the inspection circuit includes a comparison circuit configured to compare a voltage of the drive signal with a reference voltage, and a determination circuit configured to determine an abnormality based on an expected value corresponding to a level of the drive signal and a comparison result of the comparison circuit, and the driver control circuit controls a gate of a drive transistor of the driver circuit such that the drive transistor outputs the drive signal at a constant current in a determination mode.

Another aspect of the present disclosure relates to a display device including the display driver described above and the electro-optical panel.

### BRIEF DESCRIPTION OF THE DRAWINGS

FIG. 1 shows a configuration example of a display device according to an embodiment.

FIG. 2 shows a detailed configuration example of the display device.

FIG. 3 shows an example of arrangement of segment electrodes and wiring of segment signal lines.

FIG. 4 shows an example of arrangement of common electrodes and wiring of common signal lines.

FIG. 5 shows a detailed configuration example of an inspection circuit and a driver circuit.

FIG. 6 shows a detailed configuration example of the inspection circuit and the driver circuit.

FIG. 7 shows a configuration and an operation of a driver control circuit.

FIG. 8 shows a configuration example of a comparative example.

FIG. 9 shows the configuration and the operation of the driver control circuit.

FIG. 10 shows the configuration and the operation of the driver control circuit.

FIG. 11 shows a configuration example of a current setting circuit.

FIG. 12 shows a configuration example of a current setting circuit.

FIG. 13 shows a relationship between a short circuit resistance value and a voltage of a monitor signal according to the comparative example.

FIG. 14 shows a relationship between a short circuit resistance value and a voltage of a monitor signal according to the embodiment.

FIG. 15 is a signal waveform diagram showing an operation of the display device according to the embodiment.

FIG. 16 is a signal waveform diagram showing the operation of the display device according to the embodiment.

### DESCRIPTION OF EMBODIMENTS

Hereinafter, an embodiment will be described. The embodiment to be described below does not unduly limit the contents described in the claims. Not all configurations described in the embodiment are necessarily essential components.

### 1. Display Device

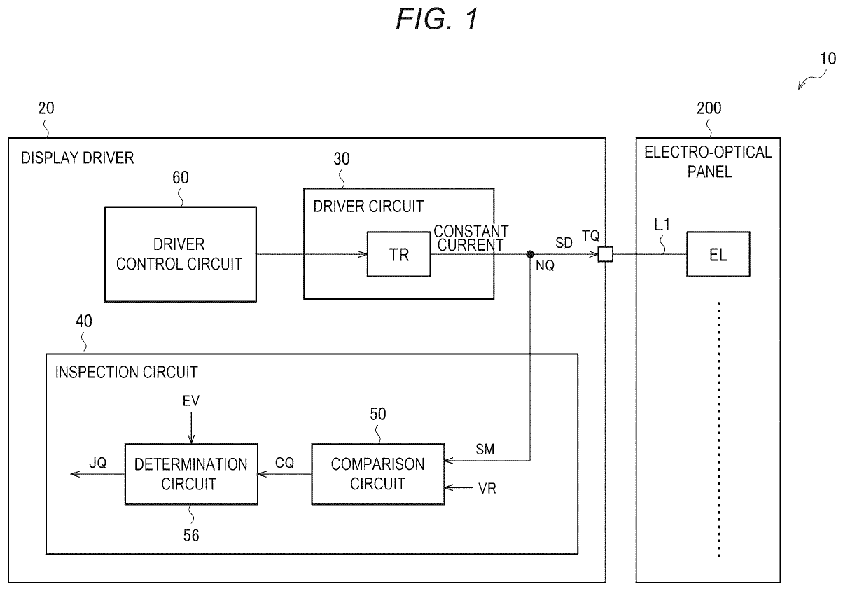

FIG. 1 shows a configuration example of a display device 10 according to the embodiment. The display device 10 includes a display driver 20 and an electro-optical panel 200. The display driver 20 includes a driver circuit 30, an inspection circuit 40, a driver control circuit 60, and an output terminal TQ. A plurality of display electrodes EL are provided in the electro-optical panel 200. The display device 10 is not limited to the configuration in FIG. 1, and various modifications such as omission of a part of these constituents, addition of other constituents, or replacement of a part of these constituents with other constituents can be made.

The display driver 20 is a circuit that performs driving for displaying an image on the electro-optical panel 200, and is implemented by, for example, a circuit device called an integrated circuit (IC). The circuit device is manufactured by a semiconductor process, and is a semiconductor chip in which circuit elements are formed on a semiconductor substrate. The display driver 20 is mounted on, for example, a glass substrate of the electro-optical panel 200. For example, the display driver 20 is mounted on the glass substrate at which the display electrodes EL are provided. Alternatively, the display driver 20 may be mounted on a circuit substrate, and the circuit substrate and the electro-optical panel 200 may be coupled by a flexible substrate.

The electro-optical panel 200 is a display panel such as a liquid crystal panel. The electro-optical panel 200 includes the plurality of display electrodes EL and a plurality of electro-optical elements. The electro-optical element is, for example, a liquid crystal element. Pixels of the electro-optical panel 200 are implemented by the display electrode EL and the electro-optical element, and an image is displayed on the electro-optical panel 200.

The display device 10 is, for example, a device that displays an image based on image data. The display device 10 is also called a display module or an electro-optical device. The display device 10 is, for example, an in-vehicle display instrument such as a cluster display which is a display of a meter panel, a center information display, a head-up display that displays a virtual image in a field of view of a user, or an electronic mirror. The in-vehicle display instrument is a display device provided in a motor vehicle such as a four-wheel or two-wheel motor vehicle. Alternatively, the display device 10 may be a display device provided in a vehicle other than a car, such as a ship, a head mounted display device called an HMD, a television device, or a display of an information processing device.

The display driver 20 includes the driver circuit 30, the inspection circuit 40, the driver control circuit 60, and the output terminal TQ.

The driver circuit 30 outputs a drive signal SD for driving the electro-optical panel 200. When the electro-optical panel 200 is a segment liquid crystal panel, the driver circuit 30 outputs a segment drive signal for driving a segment electrode or a common drive signal for driving a common electrode as the drive signal SD.

The output terminal TQ is a terminal that outputs the drive signal SD to the display electrode EL of the electro-optical panel 200. The output terminal TQ is, for example, a pad of the display driver 20 which is a circuit device. For example, in a pad region, a metal layer is exposed through a passivation film, which is an insulating layer, and the exposed metal layer constitutes the pad, which is a terminal of the display driver 20. The terminals may be external coupling terminals of a package that houses the display driver 20.

The inspection circuit 40 is a circuit that inspects an abnormal state such as a short circuit or disconnection of a signal line or the like of the electro-optical panel 200, and includes a comparison circuit 50 and a determination circuit 56.

The comparison circuit 50 compares a voltage of a monitor signal SM of the drive signal SD with a reference voltage VR. For example, a signal line L1 having one end coupled to the display electrode EL is wired in the electro-optical panel 200. The drive signal SD from the driver circuit 30 is output to the display electrode EL through the signal line L1.

The drive signal SD is output to the display electrode EL of the electro-optical panel 200 through the output terminal TQ in this way, and is input to the inspection circuit 40 as the monitor signal SM. That is, a voltage of the drive signal SD is equal to the voltage of the monitor signal SM. For example, in FIG. 1, one end of a signal line is coupled to a coupling line coupling an output node NQ and the output terminal TQ of the driver circuit 30, the other end of the signal line is coupled to the inspection circuit 40, and the drive signal SD is input to the inspection circuit 40 as the monitor signal SM through the signal line. Then, the inspection circuit 40 inspects whether an abnormality of the signal line is detected based on the monitor signal SM. It can also be said that the monitor signal SM is a signal fed back from the display electrode EL driven by the drive signal SD. A modification is also possible in which an input terminal (not shown) is provided in the display driver 20, in which a signal line coupling the input terminal and the display electrode EL is provided in the electro-optical panel 200, and in which a signal received from the display electrode EL through the signal line and the input terminal is input to the inspection circuit 40 as the monitor signal SM of the drive signal SD.

The comparison circuit 50 compares the voltage of the received monitor signal SM with the reference voltage VR and outputs a signal CQ indicating a comparison result, and the determination circuit 56 detects an abnormality based on the comparison result. The reference voltage VR is a threshold voltage for determination. In this case, the comparison circuit 50 may compare two or more reference voltages VR with the voltage of the monitor signal SM. For example, the comparison circuit 50 may compare the reference voltage on a high potential side with the voltage of the monitor signal SM, compare the reference voltage on a low potential side with the voltage of the monitor signal SM, and output a comparison result. Coupling in the embodiment is electrical coupling. The electrical coupling is coupling in which an electric signal can be transmitted and in which information can be transmitted by the electric signal. The electrical coupling may be coupling through a passive element or the like.

The determination circuit 56 determines an abnormality based on an expected value EV corresponding to a voltage level of the drive signal SD and the comparison result of the comparison circuit 50. For example, the determination circuit 56 determines a driving abnormality in which driving of the display electrode EL is abnormal. For example, the determination circuit 56 determines an abnormality of the signal line. Then, the determination circuit 56 outputs a signal JQ indicating a determination result of the abnormality. For example, the determination circuit 56 determines whether an abnormal state such as a short circuit or disconnection of the signal line L1 has occurred based on a signal of the expected value EV and the signal CQ of the comparison result from the comparison circuit 50, and outputs the signal JQ indicating that such an abnormality has occurred. The expected value EV is a value expected as a voltage level of a signal output as the drive signal SD by the driver circuit 30. For example, the expected value EV is a value that is a first logic level when the driver circuit 30 outputs the drive signal SD at a high level and that is a second logic level when the driver circuit 30 outputs the drive signal SD at a low level. In the following description, it is assumed that the first logic level is a high level and the second logic level is a low level. Alternatively, the first logic level may be a low level and the second logic level may be a high level. The high level of the drive signal SD of the driver circuit 30 corresponds to, for example, a high level of a drive power supply voltage used for driving the electro-optical panel 200, and a high level of the expected value EV corresponds to, for example, a high level of a logic power supply voltage.

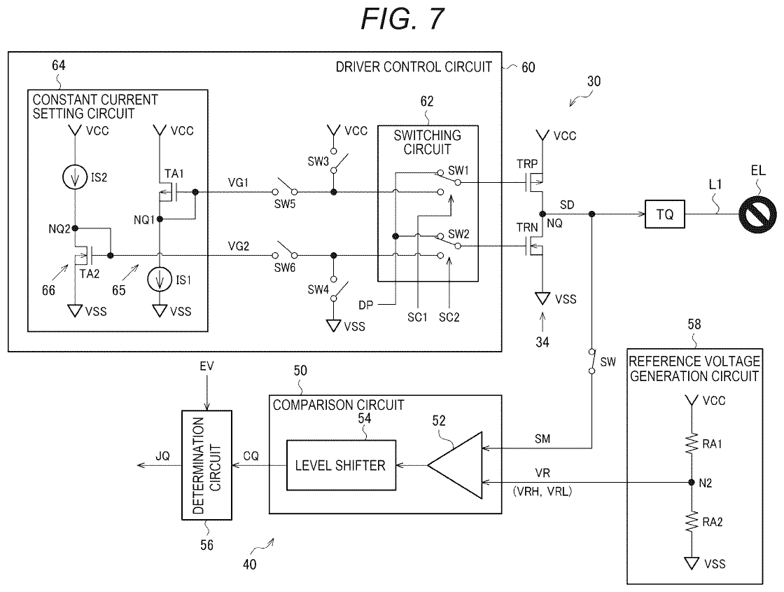

The driver circuit 30 includes a drive transistor TR. The drive transistor TR is a transistor that outputs the drive signal SD. For example, the drive signal SD is output from a drain of the drive transistor TR. A display signal corresponding to data for display is input to a gate of the drive transistor TR in a normal operation mode. Specifically, the driver circuit 30 is provided with, for example, a P-type drive transistor TRP and an N-type drive transistor TRN as the drive transistor TR as shown in FIG. 7 to be described later. The drive signal SD is output from the output node NQ of the driver circuit 30, which is a coupling node between a drain of the P-type drive transistor TRP and a drain of the N-type drive transistor TRN. In the normal operation mode, a display signal DP is input to a gate of the P-type drive transistor TRP and a gate of the N-type drive transistor TRN.

The driver control circuit 60 is a circuit that controls the driver circuit 30. For example, the driver control circuit 60 executes control for outputting the constant current drive signal SD to the driver circuit 30. Specifically, in a determination mode, the driver control circuit 60 controls the gate of the drive transistor TR of the driver circuit 30 such that the drive transistor TR outputs the drive signal SD at a constant current. For example, the driver control circuit 60 controls the gate of the drive transistor TR such that a constant current flows through the drive transistor TR provided between a node of the power supply voltage and the output node NQ, thereby causing the constant current drive signal SD to be output from the output node NQ.

For example, as shown in FIG. 7 to be described later, it is assumed that the P-type drive transistor TRP and the N-type drive transistor TRN are provided as the drive transistor TR. In this case, in a first determination mode, the driver control circuit 60 controls the gate of the P-type drive transistor TRP provided between a node of a power supply voltage VCC on the high potential side and the output node NQ such that a constant current flows through the drive transistor TRP. In a second determination mode, the driver control circuit 60 controls the gate of the N-type drive transistor TRN provided between the output node NQ and a node of a power supply voltage VSS on the low potential side such that a constant current flows through the drive transistor TRN.

For example, in the normal operation mode, the driver control circuit 60 causes the display signal DP based on data for display to be input to the gate of the drive transistor TR. In the determination mode, the driver control circuit 60 controls the gate of the drive transistor TR of the driver circuit 30 such that the drive signal SD is output at a constant current. The normal operation mode is a mode in which the display driver 20 drives the electro-optical panel 200 based on display data and causes the display electrodes EL to normally display an image. The determination mode is a mode for determining a driving abnormality of the drive signal SD due to a short circuit, a disconnection, or the like. The determination mode may be referred to as a determination period, and the normal operation mode may be referred to as a normal operation period. The determination mode is set in, for example, a start-up period due to power-on or the like of the display driver 20. Then, in the determination mode, the inspection circuit 40 inspects the abnormal state, then the operation mode transitions to the normal operation mode, and the display driver 20 performs driving based on the display data to display an image on the electro-optical panel 200.

As described above, the display driver 20 according to the embodiment includes the driver circuit 30, the output terminal TO that outputs the drive signal SD from the driver circuit 30 to the display electrode EL, the inspection circuit 40, and the driver control circuit 60. The comparison circuit 50 of the inspection circuit 40 compares the voltage of the monitor signal SM of the drive signal SD with the reference voltage VR, and the determination circuit 56 determines an abnormality such as a short circuit of the signal line based on the expected value EV corresponding to the voltage level of the drive signal SD and the comparison result of the comparison circuit 50. Then, in the determination mode, the driver control circuit 60 controls the gate of the drive transistor TR of the driver circuit 30 such that the drive transistor TR outputs the drive signal SD at the constant current. In this way, even when an abnormality such as a short circuit occurs in the signal line L1 of the drive signal SD, it is possible to prevent an overcurrent from flowing through the drive transistor TR, or to prevent the determination accuracy of the determination circuit 56 of the inspection circuit 40 from deteriorating due to a voltage change of the monitor signal SM.

For example, an abnormality such as short-circuiting of the signal line L1 of the drive signal SD to a wiring having a potential different from that of the signal line L1 may occur. When such an abnormality such as a short circuit occurs, an overcurrent may flow from the node of the power supply voltage through the drive transistor TR, and a failure such as a breakdown of a circuit (a circuit element such as a transistor) of the transistor of the display driver 20 may occur. Alternatively, the voltage of the monitor signal SM of the drive signal SD may change due to an abnormality such as a short circuit, and the determination accuracy of the determination circuit 56 of the inspection circuit 40 may deteriorate. This determination accuracy can also be referred to as detection accuracy of the inspection circuit 40.

In this regard, in the display driver 20 according to the embodiment, in the determination mode, the drive transistor TR of the driver circuit 30 is controlled to output the drive signal SD at the constant current. Therefore, even when an abnormality such as a short circuit occurs, the current flowing from the node of the power supply voltage through the drive transistor TR is limited to the constant current, and it is possible to prevent a failure of the circuit from occurring due to an overcurrent flowing. The constant current drive signal SD is output in the determination mode, so that it is possible to prevent the voltage of the monitor signal SM of the drive signal SD from changing due to a short circuit resistance value or the like. Therefore, it is possible to implement the display driver 20 capable of preventing the occurrence of the overcurrent and the deterioration of the determination accuracy due to the abnormality of the drive signal SD.

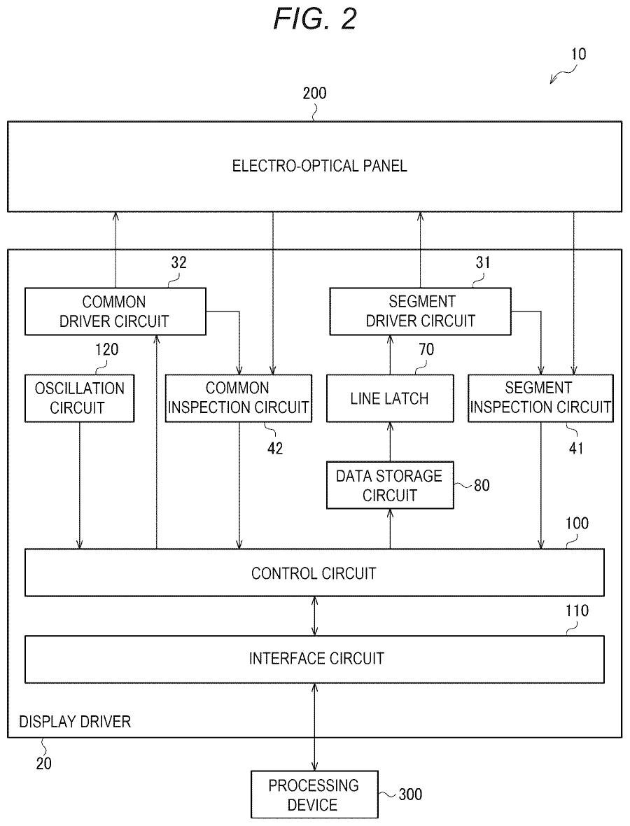

FIG. 2 shows a detailed configuration example of the display driver 20 and the display device 10 according to the embodiment. In FIG. 2, the display device 10 includes the display driver 20, the electro-optical panel 200, and a processing device 300. The display driver 20 and the display device 10 are not limited to the configuration in FIG. 2, and various modifications such as omission of a part of these constituents, addition of other constituents, or replacement of a part of these constituents with other constituents can be made.

The electro-optical panel 200 is, for example, a panel driven by a static driving method. Specifically, the electro-optical panel 200 includes a first glass substrate, a second glass substrate, and a liquid crystal. The liquid crystal which is the electro-optical element is sealed between the first glass substrate and the second glass substrate. The segment electrode is provided at the first glass substrate, and the common electrode is provided at the second glass substrate. The display driver 20 outputs a segment drive signal to the segment electrode. The display driver 20 outputs a common drive signal to the common electrode. Accordingly, a drive signal whose voltage is a potential difference between the segment drive signal and the common drive signal is applied to the liquid crystal between the segment electrode and the common electrode. The segment electrode and the common electrode are transparent electrodes, and are made of, for example, indium tin oxide (ITO). Hereinafter, a case in which the electro-optical panel 200 is a segment liquid crystal panel including a segment electrode and a common electrode as the display electrode EL in this way will be mainly described as an example, and the embodiment is not limited thereto.

The processing device 300 is, for example, a host device for the display driver 20, and is implemented by, for example, a processor or a display controller. The processor is, for example, a CPU or a microcomputer. The processing device 300 may be a circuit device implemented by a plurality of circuit components. For example, the processing device 300 may be an electronic control unit (ECU) in an in-vehicle electronic instrument.

The display driver 20 includes a segment driver circuit 31, a common driver circuit 32, a segment inspection circuit 41, a common inspection circuit 42, a line latch 70, a data storage circuit 80, a control circuit 100, an interface circuit 110, and an oscillation circuit 120. The segment driver circuit 31 and the common driver circuit 32 correspond to the driver circuit 30 in FIG. 1, and the segment inspection circuit 41 and the common inspection circuit 42 correspond to the inspection circuit 40 in FIG. 1. That is, in this case, the display driver 20 includes a plurality of inspection circuits 40.

The segment driver circuit 31 outputs a segment drive signal to drive the segment electrode of the electro-optical panel 200. For example, the segment driver circuit 31 drives the electro-optical panel 200 by a static driving method or a duty driving method. For example, the display driver 20 includes an output terminal from which a segment drive signal is output, and the segment drive signal is output to the segment electrode of the electro-optical panel 200 through the output terminal. In this case, the drive signal SD, the display electrode EL, and the output terminal TQ in FIG. 1 correspond to the segment drive signal, the segment electrode, and the output terminal for the segment drive signal described above, respectively.

The common driver circuit 32 outputs a common drive signal to drive the common electrode of the electro-optical panel 200. For example, the display driver 20 includes an output terminal from which a common drive signal is output, and the common drive signal is output to the common electrode of the electro-optical panel 200 through the output terminal. In this case, the drive signal SD, the display electrode EL, and the output terminal TQ in FIG. 1 correspond to the common drive signal, the common electrode, and the output terminal for the common drive signal described above, respectively. That is, in this case, the display driver 20 includes a plurality of output terminals TQ.

The segment inspection circuit 41 is a circuit that inspects an abnormality of a signal line or the like of the segment electrode. For example, the segment inspection circuit 41 inspects whether an abnormality such as a short circuit or disconnection has occurred in the signal line or the like of the segment electrode. The common inspection circuit 42 is a circuit that inspects an abnormality of a signal line or the like of the common electrode. For example, the common inspection circuit 42 inspects whether an abnormality such as a short circuit or disconnection has occurred in the signal line or the like of the common electrode. The segment inspection circuit 41 and the common inspection circuit 42 correspond to the inspection circuit 40 in FIG. 1. That is, in this case, the display driver 20 includes the plurality of inspection circuits 40.

The data storage circuit 80 is a circuit that stores data for display and the like, and can be implemented by a memory such as a RAM. The data storage circuit 80 stores data for display of the electro-optical panel 200. The data for display is, for example, on/off data or gradation data based on which a displayed object corresponding to a segment electrode is displayed. The data for display is received from, for example, the processing device 300 through the interface circuit 110 and stored in the data storage circuit 80.

The line latch 70 latches the data for display from the data storage circuit 80. The line latch 70, which is a data latch, latches the data for display from the data storage circuit 80 based on, for example, a latch signal from the control circuit 100. Then, the segment driver circuit 31 generates and outputs a segment drive signal based on the data latched by the line latch 70. The line latch 70 is implemented by a flip-flop circuit or the like.

The control circuit 100 is, for example, a logic circuit that operates based on a clock signal from the oscillation circuit 120. The control circuit 100 can be implemented by, for example, an application specific integrated circuit (ASIC) using an automatic wiring technology, such as a gate array, or a processor such as a CPU. The control circuit 100 executes control of a display timing, an operation setting of the display driver 20, and the like.

The interface circuit 110 is a circuit that serves as an interface with the external processing device 300, and executes communication between the processing device 300 and the display driver 20. For example, the interface circuit 110 receives command data, display data, and other various types of data from the processing device 300. The interface circuit 110 can be implemented by, for example, a serial interface circuit based on the inter integrated circuit (I2C) protocol, the serial peripheral interface (SPI) protocol, or the like.

The oscillation circuit 120 generates an oscillation signal and outputs a clock signal based on the oscillation signal. Circuits of the display driver 20 such as the control circuit 100 operate based on the clock signal.

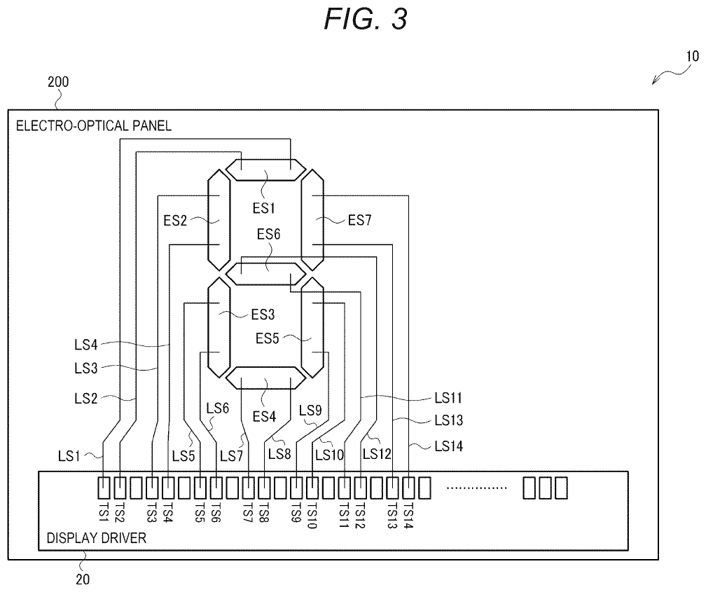

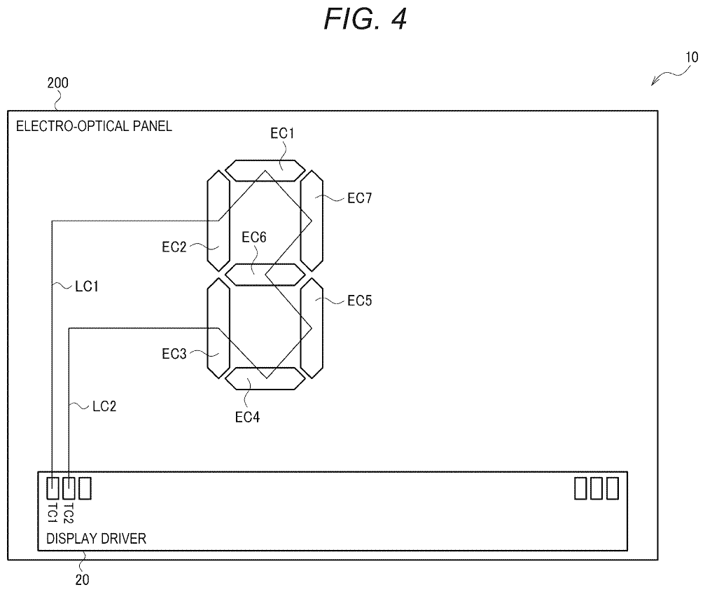

FIG. 3 shows an example of arrangement of segment electrodes and wiring of segment signal lines of the electro-optical panel 200, and FIG. 4 shows an example of arrangement of common electrodes and wiring of common signal lines.

In FIG. 3, segment electrodes ES1 to ES7 and segment signal lines LS1 to LS14 are provided in the electro-optical panel 200. Segment terminals TS1 and TS2 of the display driver 20 are coupled to the segment electrode ES1 by the segment signal lines LS1 and LS2, respectively. Segment terminals TS3 and TS4 of the display driver 20 are coupled to the segment electrode ES2 by the segment signal lines LS3 and LS4, respectively. The same applies to coupling between segment terminals TS5 to TS14 and the segment electrodes ES3 to ES7 by the segment signal lines LS5 to LS14. Each of the segment terminals TS1, TS3, TS5, TS7, TS9, TS11, and TS13 in FIG. 3 corresponds to the output terminal TQ in FIG. 1 from which the drive signal SD is output.

In FIG. 3, the segment signal lines LS2, LS4, LS6, LS8, LS10, LS12, and LS14 through which a monitor signal serving as feedback signals from the segment electrodes ES1 to ES7 is input to the display driver 20 are provided in the electro-optical panel 200. The segment terminals TS2, TS4, TS6, TS8, TS10, TS12, and TS14 which are input terminals of the monitor signal are provided in the display driver 20. The segment inspection circuit 41 can determine an abnormality based on the monitor signal input in this way. Alternatively, the segment terminal and the segment signal line for feedback may not be provided. Although FIG. 3 shows an example in which the segment electrode is an electrode for 7-segment display, and the segment electrodes may be electrodes of various types, such as icon electrodes for warning lights and the like.

In FIG. 4, the electro-optical panel 200 is provided with common electrodes EC1 to EC7 and common signal lines LC1 and LC2. Common terminals TC1 and TC2 of the display driver 20 are coupled to the common electrodes EC1 to EC7 by the common signal lines LC1 and LC2, respectively. The common terminal TC1 in FIG. 4 corresponds to the output terminal TQ in FIG. 1 from which the drive signal SD is output.

In FIG. 4, the common signal line LC2 through which a monitor signal serving as a feedback signal from the common electrodes EC1 to EC7 is input to the display driver 20 is provided in the electro-optical panel 200. The common terminal TC2 serving as an input terminal of the monitor signal is provided in the display driver 20. The common inspection circuit 42 can determine an abnormality based on the monitor signal input in this way. Alternatively, the common terminal and the common signal line for feedback may not be provided.

### 2. Inspection Circuit and Driver Circuit

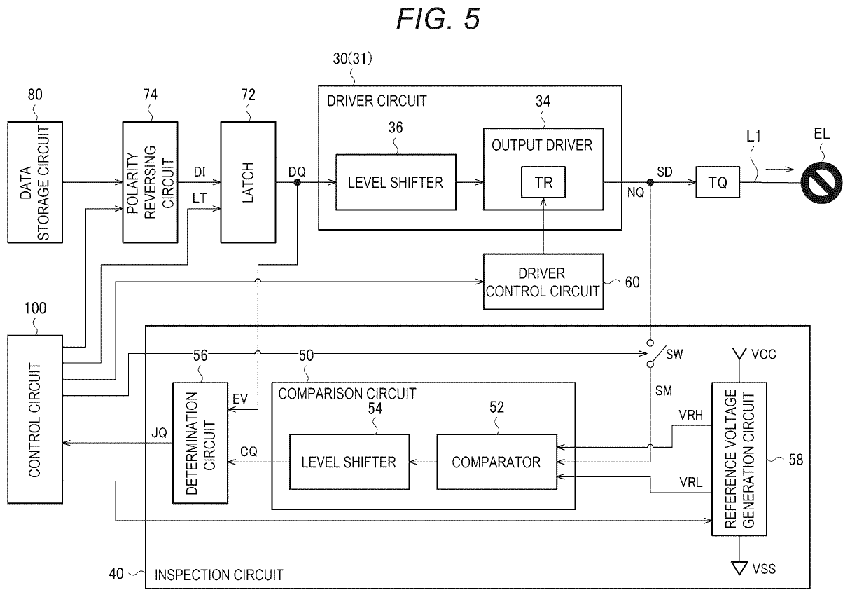

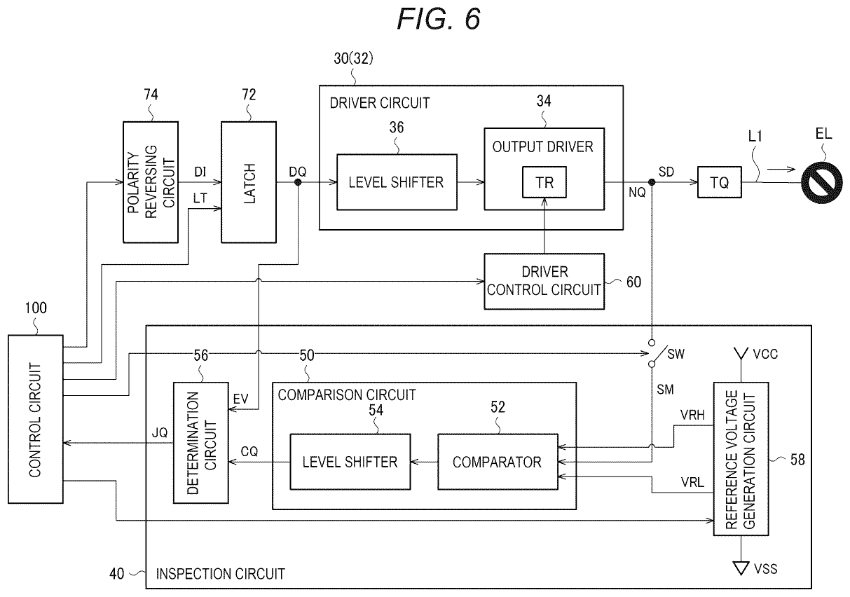

FIGS. 5 and 6 show detailed configuration examples of the inspection circuit 40 and the driver circuit 30. FIG. 5 shows a configuration example in which the inspection circuit 40 and the driver circuit 30 are the segment inspection circuit 41 and the segment driver circuit 31 in FIG. 2, respectively. FIG. 6 shows a configuration example in which the inspection circuit 40 and the driver circuit 30 are the common inspection circuit 42 and the common driver circuit 32 in FIG. 2, respectively. Therefore, in FIG. 5, the driver circuit 30 outputs the drive signal SD for the segment based on the data for display from the data storage circuit 80. In contrast, in FIG. 6, such data for display is not input, and the driver circuit 30 outputs the drive signal SD for the common under the control of the control circuit 100. In the following, for simplification of description, the configuration in FIG. 5 will be mainly described as an example.

A polarity reversing circuit 74 performs polarity reversing processing of the data for display of the segment read from the data storage circuit 80 based on a polarity signal received from the control circuit 100. For example, the polarity reversing circuit 74 outputs data DI having the same logic level as the data for display in a positive polarity frame, and outputs the data DI obtained by reversing a logic level of the data for display in a negative polarity frame. A latch 72 latches the data DI from the polarity reversing circuit 74 based on a latch signal LT from the control circuit 100. The latch 72 is a latch constituting the line latch 70 in FIG. 2, and is implemented by, for example, a flip-flop circuit.

The driver circuit 30 includes a level shifter 36 and an output driver 34. The level shifter 36 receives latched data DQ from the latch 72 and executes level shift for a signal of the data DQ. For example, the level shifter 36 executes level shift of converting a logic power supply voltage level into a driving power supply voltage level of the electro-optical panel 200. Then, the output driver 34 outputs the drive signal SD based on a display signal after the level shift executed by the level shifter 36.

The inspection circuit 40 includes the comparison circuit 50, the determination circuit 56, a reference voltage generation circuit 58, and a switch SW. The comparison circuit 50 includes a comparator 52 and a level shifter 54.

The switch SW is turned on when the inspection circuit 40 is in the determination mode for determining a drive abnormality. Accordingly, the monitor signal SM corresponding to the drive signal SD is input to the comparator 52 of the comparison circuit 50 through the switch SW that is turned on.

The reference voltage generation circuit 58 generates reference voltages VRH and VRL based on the power supply voltages VCC and VSS. VCC is a drive power supply voltage on the high potential side of the electro-optical panel 200, and VSS is a power supply voltage on the low potential side. For example, the reference voltage generation circuit 58 includes a ladder resistor circuit including a plurality of resistors coupled in series to the node of VCC and the node of VSS, and generates the reference voltages VRH and VRL by voltage division by the plurality of resistors. The reference voltage VRH is a reference voltage on the high potential side which is a VCC side, and the reference voltage VRL is a reference voltage on the low potential side which is a VSS side. The reference voltage VRH is, for example, a voltage of approximately 60% to 90% of VCC, and the reference voltage VRL is, for example, a voltage of approximately 10% to 40% of VCC. For example, the reference voltage VRH is a voltage of approximately 70% of VCC, and the reference voltage VRL is a voltage of approximately 30% of VCC.

The comparator 52 of the comparison circuit 50 compares the voltage of the monitor signal SM of the drive signal SD with the reference voltages VRH and VRL, and a comparison result thereof is output from the comparison circuit 50 as the signal CQ through the level shifter 54. The level shifter 54 executes level shift of converting the driving power supply voltage level of the electro-optical panel 200 into the logic power supply voltage level. For example, when the voltage of the monitor signal SM is higher than the reference voltage VRH on the high potential side, the comparison circuit 50 outputs the signal CQ of the first logic level which is a high level. When the voltage of the monitor signal SM is lower than the reference voltage VRL on the low potential side, the comparison circuit 50 outputs the signal CQ of the second logic level which is a low level. The comparison circuit 50 may output the signal CQ indicating an inspection error when the voltage of the monitor signal SM is a voltage between the reference voltage VRH on the high potential side and the reference voltage VRL on the low potential side.

The data DQ from the latch 72 is input to the determination circuit 56 as the expected value EV. For example, when the driver circuit 30 outputs the drive signal SD at a high level, the high level expected value EV is input to the determination circuit 56. When the driver circuit 30 outputs the drive signal SD at a low level, the low level expected value EV is input to the determination circuit 56. Then, the determination circuit 56 compares the expected value EV with the signal CQ of the comparison result from the comparison circuit 50 to determine whether an abnormality has occurred.

For example, when the drive signal SD is at a high level and the expected value EV is at a high level, when the voltage of the monitor signal SM is higher than the reference voltage VRH and the signal CQ is at a high level, the determination circuit 56 determines that no abnormality has occurred. On the other hand, when the expected value EV is at a high level, when the signal CQ is a signal at a low level or a signal indicating a detection error, it is determined that an abnormality has occurred.

When the drive signal SD is at a low level and the expected value EV is at a low level, when the voltage of the monitor signal SM is lower than the reference voltage VRL and the signal CQ is at a low level, the determination circuit 56 determines that no abnormality has occurred. On the other hand, when the expected value EV is at a low level, when the signal CQ is a signal at a high level or a signal indicating a detection error, it is determined that an abnormality has occurred.

In this way, when the driver circuit 30 outputs the drive signal SD at a high level to the display electrode EL, when the voltage of the monitor signal SM is a voltage corresponding to the high level, the determination circuit 56 can determine that no abnormality has occurred. When the driver circuit 30 outputs the drive signal SD at a low level to the display electrode EL, when the voltage of the monitor signal SM is a voltage corresponding to the low level, the determination circuit 56 can determine that no abnormality has occurred.

### 3. Driver Control Circuit

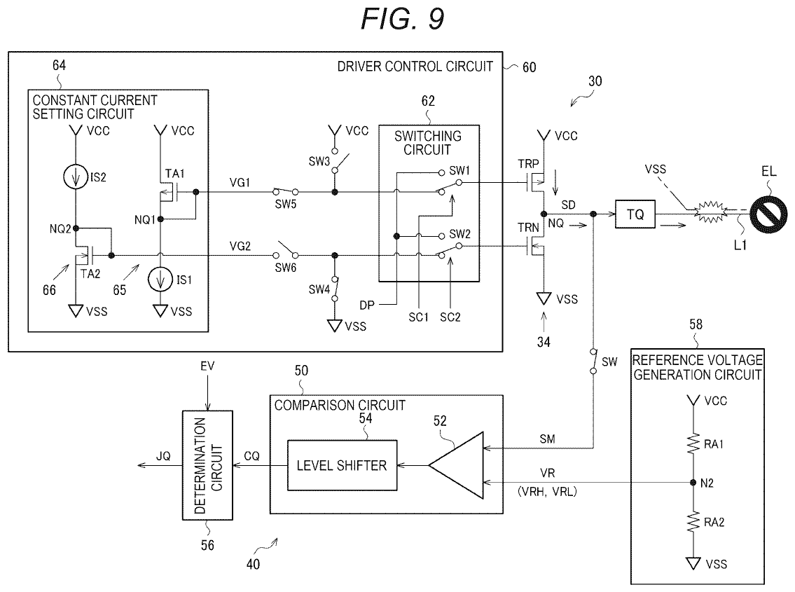

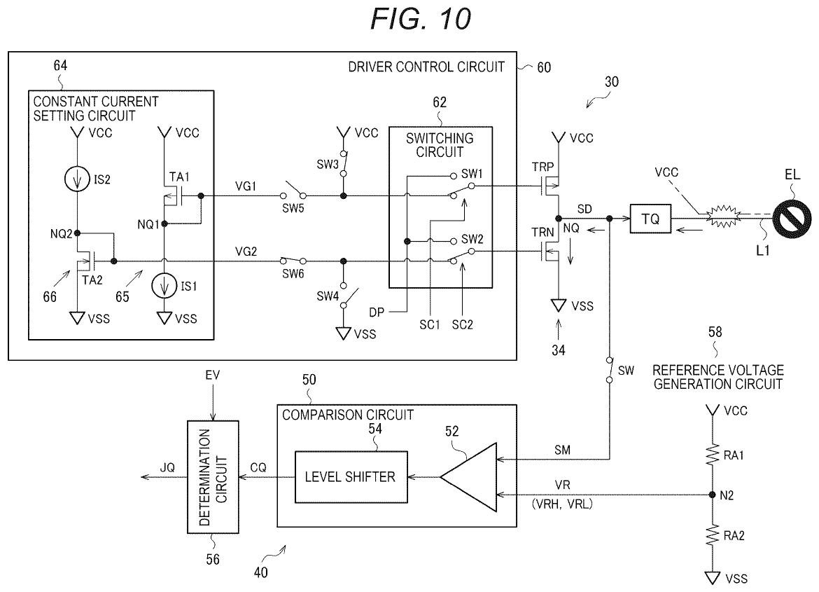

Next, a configuration and an operation of the driver control circuit 60 according to the embodiment will be described in detail. FIG. 7 shows the configuration and the operation of the driver control circuit 60. FIGS. 9 and 10 to be described later also show the configuration and the operation of the driver control circuit 60 according to the embodiment.

As shown in FIG. 7, the driver control circuit 60 includes a switching circuit 62 and a constant current setting circuit 64. The driver control circuit 60 can further include switch circuits SW3, SW4, SW5, and SW6. The switching circuit 62 includes switch circuits SW1 and SW2. The switch circuit SW1 is a first switch circuit, and the switch circuit SW2 is a second switch circuit. The constant current setting circuit 64 includes current setting circuits 65 and 66. The current setting circuit 65 is a first current setting circuit, and the current setting circuit 66 is a second current setting circuit.

The output driver 34 of the driver circuit 30 includes the P-type drive transistor TRP and the N-type drive transistor TRN. The drive transistors TRP and TRN are provided in series between the node of the power supply voltage VCC on the high potential side and the node of the power supply voltage VSS on the low potential side. The drive signal SD is output from the output node NQ which is a coupling node of the drains of the drive transistors TRP and TRN.

The reference voltage generation circuit 58 includes resistors RA1 and RA2 provided in series between the node of the power supply voltage VCC on the high potential side and the node of the power supply voltage VSS on the low potential side. The reference voltage VR is generated and output to a coupling node N2 between the resistor RA1 and the resistor RA2. Although it is desirable to generate two reference voltages VRH and VRL on the high potential side and the low potential side as shown in FIGS. 5 and 6 for accurate abnormality detection, a case in which one reference voltage VR is used will be mainly described below as an example for simplification of description.

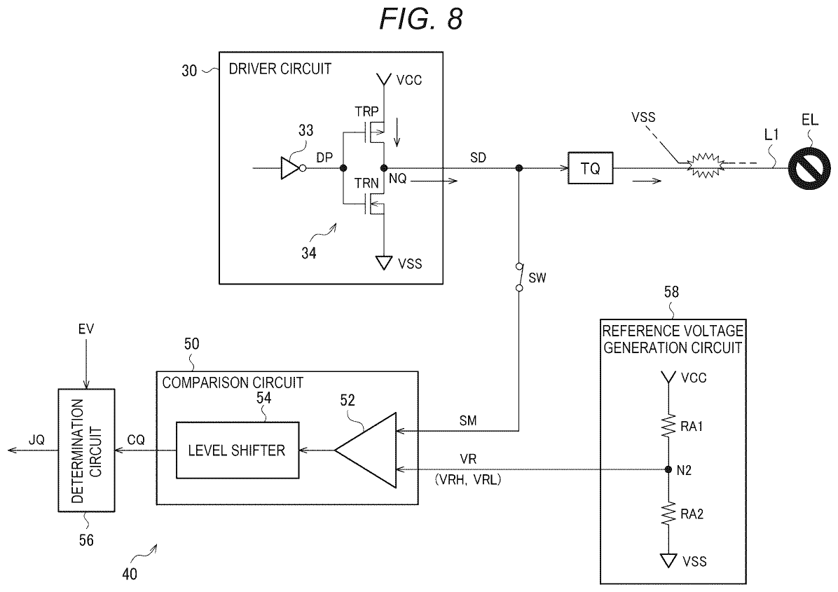

For example, FIG. 8 shows a configuration example of a comparative example of the embodiment. In the comparative example in FIG. 8, the driver control circuit 60 as shown in FIG. 7 is not provided. The driver circuit 30 includes a pre-buffer circuit 33 formed of an inverter circuit, and the output driver 34 that receives the display signal DP output from the pre-buffer circuit 33 and that outputs the drive signal SD.

In FIG. 8, a short circuit occurs in the signal line L1 to which the drive signal SD is output. Specifically, in FIG. 8, the signal line L1 of the drive signal SD is short-circuited to a potential on the VSS side. Accordingly, a short circuit current flows from the node of VCC to the potential of VSS through the drive transistor TRP of the driver circuit 30. In this case, when a short circuit resistance value, which is a resistance value at a short-circuited location, is low, an overcurrent flows as a short circuit current. When such an overcurrent flows, a failure such as breakdown of the circuit of the display driver 20 may occur. Depending on the magnitude of the short circuit resistance value, the voltage of the monitor signal SM of the drive signal SD changes, and the determination accuracy of the inspection circuit 40 may deteriorate. In FIG. 8, even when the signal line L1 of the drive signal SD is short-circuited to the potential on the VCC side, a short circuit current flows from the potential of VCC to the node of VSS through the drive transistor TRN of the driver circuit 30, which causes a problem of a circuit failure due to an overcurrent or deterioration of the determination accuracy.

In this regard, in the embodiment, the driver control circuit 60 controls the gates of the drive transistor TRP and the drive transistor TRN of the driver circuit 30 such that the drive transistor TRP and the drive transistor TRN output the drive signal SD at a constant current in the determination mode. In this way, even when an abnormality such as a short circuit occurs in the signal line L1 of the drive signal SD, the short circuit current is limited to the constant current. Therefore, it is possible to prevent the occurrence of problems such as an overcurrent flow and deterioration in the determination accuracy of the inspection circuit 40.

Specifically, as shown in FIG. 7, the driver control circuit 60 includes the switching circuit 62 and the constant current setting circuit 64. The constant current setting circuit 64 generates gate voltages VG1 and VG2 of the drive transistors TRP and TRN of the driver circuit 30 for outputting the drive signal SD at a constant current to the drive transistors TRP and TRN. For example, the constant current setting circuit 64 generates and outputs the gate voltage VG1 for causing a constant current to flow between a source and the drain of the drive transistor TRP. The constant current setting circuit 64 generates and outputs the gate voltage VG2 for causing a constant current to flow between a source and the drain of the drive transistor TRN.

In the normal operation mode, the switching circuit 62 outputs the display signal DP for causing the driver circuit 30 to output the drive signal SD to the gates of the drive transistors TRP and TRN. In the determination mode, the switching circuit 62 outputs the gate voltage VG1 or the gate voltage VG2 from the constant current setting circuit 64 to the gate of the drive transistor TRP or the drive transistor TRN, respectively. In this way, in the normal operation mode, the display signal DP is input to the gates of the drive transistors TRP and TRN by the switching circuit 62, so that the driver circuit 30 can output the drive signal SD based on the display signal DP to the electro-optical panel 200. In the determination mode, the gate voltage VG1 or the gate voltage VG2 from the constant current setting circuit 64 is input to the gate of the drive transistor TRP or the drive transistor TRN by the switching circuit 62, so that the driver circuit 30 outputs the drive signal SD at a constant current.

For example, FIG. 7 shows a switching state of the switch circuit in the normal operation mode in which an image based on the display signal DP is displayed on the electro-optical panel 200. For example, in the normal operation mode, as shown in FIG. 7, the switch circuits SW1 and SW2 of the switching circuit 62 are switched to an input node side of the display signal DP by control signals SC1 and SC2 from the control circuit 100 in FIG. 5. Therefore, the display signal DP from the pre-buffer circuit or the like in a previous stage is input to the gates of the drive transistors TRP and TRN of the driver circuit 30 through the switch circuits SW1 and SW2. Accordingly, the drive signal SD based on the display signal DP is output to the electro-optical panel 200, and a normal display operation by the electro-optical panel 200 is executed.

In this case, in FIG. 7 in the normal operation mode, the switch circuits SW5 and SW6 provided between the switching circuit 62 and the constant current setting circuit 64 are turned off. Therefore, the gate voltages VG1 and VG2 from the constant current setting circuit 64 are not input to the switching circuit 62. Further, since the switch circuit SW3 for pull-up and the switch circuit SW4 for pull-down are turned off, the pull-up and pull-down by these switch circuits SW3 and SW4 are not performed.

In this way, the driver circuit 30 includes the P-type drive transistor TRP and the N-type drive transistor TRN that are provided in series between the node of the power supply voltage VCC on the high potential side and the node of the power supply voltage VSS on the low potential side as the drive transistor TR in FIG. 1. As shown in FIG. 7, the switching circuit 62 includes the switch circuit SW1 that outputs the display signal DP to the gate of the P-type drive transistor TRP in the normal operation mode, and the switch circuit SW2 that outputs the display signal DP to the gate of the N-type drive transistor TRN in the normal operation mode. The switch circuit SW1 is the first switch circuit, and the switch circuit SW2 is the second switch circuit. In this way, in the normal operation mode, the display signal DP is input to the gate of the P-type drive transistor TRP through the switch circuit SW1, and is input to the gate of the N-type drive transistor TRN through the switch circuit SW2. Accordingly, the drive signal SD based on the display signal DP is output to the electro-optical panel 200, and the normal display operation is executed.

On the other hand, FIG. 9 shows a switching state of the switch circuit in the determination mode, and specifically shows a switching state of the switch circuit when an abnormality is detected when the signal line L1 of the drive signal SD is short-circuited to the potential on the VSS side. In the determination mode which is the first determination mode, the switch circuits SW1 and SW2 of the switching circuit 62 are switched to the input node sides of the gate voltages VG1 and VG2 from the constant current setting circuit 64 by the control signals SC1 and SC2 from the control circuit 100. The switch circuit SW5 for coupling between the switching circuit 62 and the constant current setting circuit 64 is turned on, and the switch circuit SW6 is turned off. The switch circuit SW4 for pull-down to VSS is turned on, and the switch circuit SW3 for pull-up to VCC is turned off.

In this way, the constant gate voltage VG1 from the constant current setting circuit 64 is input to the gate of the P-type drive transistor TRP of the driver circuit 30 through the switch circuit SW5 and the switch circuit SW1 of the switching circuit 62. Accordingly, a constant current flows between the source and the drain of the drive transistor TRP. Therefore, even when the signal line L1 of the drive signal SD is short-circuited to the potential on the VSS side as shown in FIG. 9, it is possible to prevent the occurrence of a circuit failure due to an overcurrent flowing through the drive transistor TRP, or to prevent the deterioration in the determination accuracy due to a change in the voltage of the monitor signal SM input to the inspection circuit 40.

In FIG. 9, the switch circuit SW6 is turned off to which the gate voltage VG2 from the constant current setting circuit 64 is input, and the gate of the drive transistor TRN is pulled down to the VSS side by the switch circuit SW4 for pull-down. Therefore, it is possible to turn off the N-type drive transistor TRN while executing control such that a constant current flows through the P-type drive transistor TRP.

FIG. 10 shows a switching state of the switch circuit in the determination mode, and specifically shows a switching state of the switch circuit when an abnormality is detected when the signal line L1 of the drive signal SD is short-circuited to the potential on the VCC side. In the determination mode which is the second determination mode, the switch circuits SW1 and SW2 of the switching circuit 62 are switched to the input node sides of the gate voltages VG1 and VG2 from the constant current setting circuit 64 by the control signals SC1 and SC2 from the control circuit 100. The switch circuit SW6 for coupling between the switching circuit 62 and the constant current setting circuit 64 is turned on, and the switch circuit SW5 is turned off. The switch circuit SW3 for pull-up to VCC is turned on, and the switch circuit SW4 for pull-down to VSS is turned off.

In this way, the constant gate voltage VG2 from the constant current setting circuit 64 is input to the gate of the N-type drive transistor TRN of the driver circuit 30 through the switch circuit SW6 and the switch circuit SW2 of the switching circuit 62. Accordingly, a constant current flows between the source and the drain of the drive transistor TRN. Therefore, even when the signal line L1 of the drive signal SD is short-circuited to the potential on the VCC side as shown in FIG. 10, it is possible to prevent the occurrence of a circuit failure due to an overcurrent flowing through the drive transistor TRN, or to prevent the deterioration in the determination accuracy due to a change in the voltage of the monitor signal SM input to the inspection circuit 40.

In FIG. 10, the switch circuit SW5 is turned off to which the gate voltage VG1 from the constant current setting circuit 64 is input, and the gate of the drive transistor TRP is pulled up to the VCC side by the switch circuit SW3 for pull-up. Therefore, it is possible to turn off the P-type drive transistor TRP while executing control such that a constant current flows through the N-type drive transistor TRN.

As shown in FIGS. 7, 9, and 10, the constant current setting circuit 64 includes the current setting circuits 65 and 66. The current setting circuit 65 is the first current setting circuit, and the current setting circuit 66 is the second current setting circuit. The current setting circuit 65 includes a P-type transistor TA1 and a current source IS1 that are provided in series between the node of the power supply voltage VCC on the high potential side and the node of the power supply voltage VSS on the low potential side. The current source IS is a first current source. A gate and a drain of the P-type transistor TA1 are coupled to an output node NQ1 of the current setting circuit 65. For example, a source of the P-type transistor TA1 is coupled to the node of VCC, and the current source IS1 is provided between the output node NQ1 and the node of VSS. The current source IS1 includes, for example, a transistor for a current source.

The current setting circuit 66 includes a current source IS2 and an N-type transistor TA2 that are provided in series between the node of VCC and the node of VSS. The current source IS2 is a second current source. A gate and a drain of the N-type transistor TA2 are coupled to an output node NQ2 of the current setting circuit 66. For example, a source of the N-type transistor TA2 is coupled to the node of VSS, and the current source IS2 is provided between the node of VCC and the output node NQ2. The current source IS2 includes, for example, a transistor for a current source.

In the determination mode, the switch circuit SW1 couples the output node NQ1 of the current setting circuit 65 and the gate of the P-type drive transistor TRP as shown in FIG. 9, or the switch circuit SW2 couples the output node NQ2 of the current setting circuit 66 and the gate of the N-type drive transistor TRN as shown in FIG. 10.

In this way, by coupling the output node NQ1 of the current setting circuit 65 and the gate of the drive transistor TRP, a current mirror circuit is implemented by the transistor TA1 and the drive transistor TRP, and a constant current corresponding to the constant current flowing through the current source IS1 flows through the drive transistor TRP. Accordingly, even when the signal line L1 of the drive signal SD is short-circuited to the potential on the VSS side as shown in FIG. 9, the short circuit current flowing through the drive transistor TRP is limited to the constant current, and thus it is possible to prevent a problem of occurrence of an overcurrent or deterioration in the determination accuracy. By coupling the output node NQ2 of the current setting circuit 66 and the gate of the drive transistor TRN, a current mirror circuit is implemented by the transistor TA2 and the drive transistor TRN, and a constant current corresponding to the constant current flowing through the current source IS2 flows through the drive transistor TRN. Accordingly, even when the signal line L1 of the drive signal SD is short-circuited to the potential on the VCC side as shown in FIG. 10, the short circuit current flowing through the drive transistor TRN is limited to the constant current, and thus it is possible to prevent a problem of occurrence of an overcurrent or deterioration in the determination accuracy.

As shown in FIG. 9, when the output node NQ1 of the current setting circuit 65 and the gate of the P-type drive transistor TRP are coupled by the switch circuit SW1, the driver control circuit 60 pulls down the gate of the N-type drive transistor TRN. For example, the switch circuit SW4 provided between the gate of the drive transistor TRN and the node of VSS is turned on, so that the gate of the drive transistor TRN is pulled down to the VSS side. As shown in FIG. 10, when the output node NQ2 of the current setting circuit 66 and the gate of the N-type drive transistor TRN are coupled by the switch circuit SW2, the driver control circuit 60 pulls up the gate of the P-type drive transistor TRP. For example, the switch circuit SW3 provided between the gate of the drive transistor TRP and the node of VCC is turned on, so that the gate of the drive transistor TRP is pulled up to the VCC side.

In this way, when the output node NQ1 of the current setting circuit 65 and the gate of the P-type drive transistor TRP are coupled, the gate of the N-type drive transistor TRN is pulled down and turned off. Accordingly, when a constant current is caused to flow by the P-type drive transistor TRP, it is possible to prevent an unnecessary current from flowing through the drive transistor TRN. When the output node NQ2 of the current setting circuit 66 and the gate of the N-type drive transistor TRN are coupled, the gate of the P-type drive transistor TRP is pulled up and turned off. Accordingly, when a constant current is caused to flow by the N-type drive transistor TRN, it is possible to prevent an unnecessary current from flowing through the drive transistor TRP.

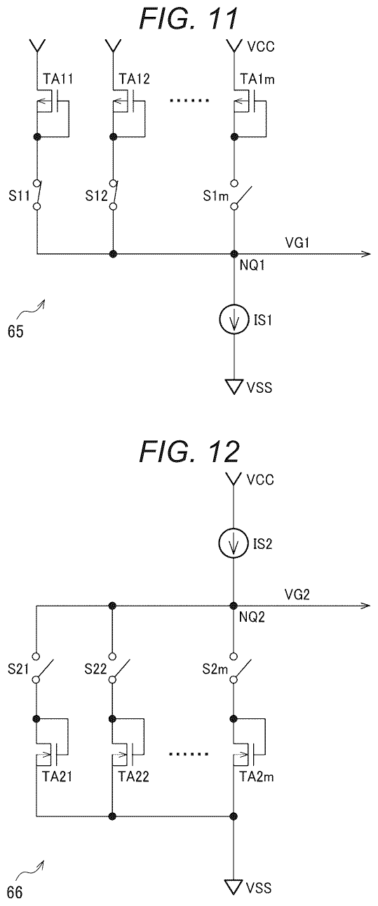

FIG. 11 shows a configuration example of the current setting circuit 65, and FIG. 12 shows a configuration example of the current setting circuit 66. In FIG. 11, the current setting circuit 65 includes a plurality of P-type transistors TA11, TA12, . . . , and TA1m provided in parallel between the node of VCC and the output node NQ1. The transistors TA11, TA12, . . . , and TA1m, which are unit transistors, constitute the transistor TA1 in FIGS. 7, 9, and 10. Here, m is an integer of 2 or more. The current setting circuit 65 includes switch circuits S11, S12, . . . , and S1m provided between the transistors TA11, TA12, . . . and TA1m and the output node NQ1. The current source IS1 is provided between the output node NQ1 and the node of VSS. In this way, by setting ON and OFF of the switch circuits S11, S12, . . . , and S1m, it is possible to set a current mirror ratio between the transistor TA1 and the drive transistor TRP, and to variably adjust a current value of the constant current flowing through the drive transistor TRP.

In FIG. 12, the current setting circuit 66 includes a plurality of N-type transistors TA21, TA22, . . . , and TA2m provided in parallel between the output node NQ2 and the node of VSS. The transistors TA21, TA22, . . . , and TA2m, which are unit transistors, constitute the transistor TA2 in FIGS. 7, 9, and 10. The current circuit 66 includes switch circuits S21, S22, . . . , and S2m provided between the output node NQ2 and the transistors TA21, TA22, . . . and TA2m. The current source IS2 is provided between the node of VCC and the output node NQ2. In this way, by setting ON and OFF of the switch circuits S21, S22, . . . , and S2m, it is possible to set a current mirror ratio between the transistor TA2 and the drive transistor TRN, and to variably adjust a current value of the constant current flowing through the drive transistor TRN.

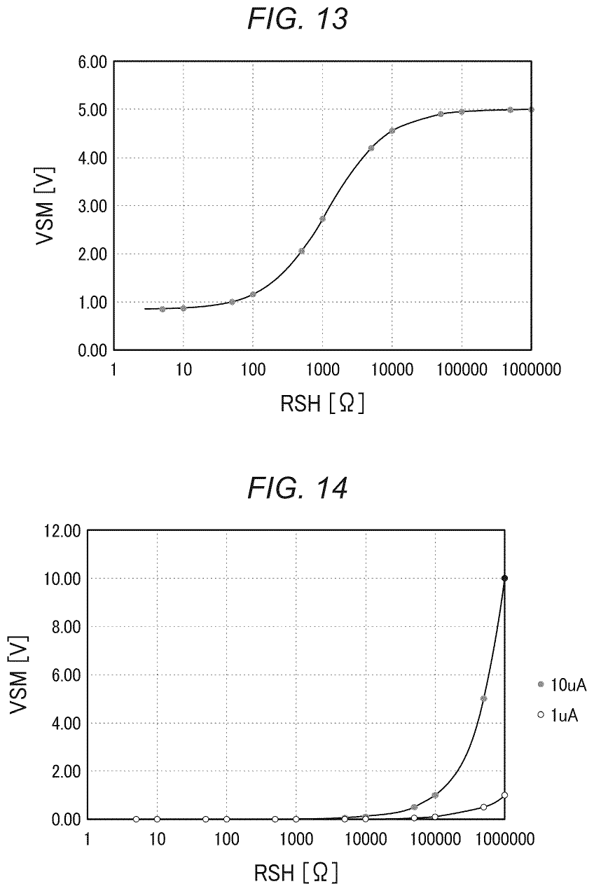

For example, FIG. 13 is a diagram showing a relationship between a short circuit resistance value RSH and a voltage VSM of the monitor signal SM according to the comparative example in FIG. 8. For example, when ON resistance values of the drive transistors TRP and TRN are denoted by RON, a resistance value to a short-circuited location of the signal line L1 of the electro-optical panel 200 is denoted by RL1, and a short circuit resistance value is denoted by RSH, a short circuit current value ISH can be expressed by the following equation (1).

$$ISH = ( VCC - VSS ) / ( RON + RL 1 + RSH ) \qquad ( 1 )$$

The short circuit resistance value RSH changes according to a contact state at the short-circuited location. When the short circuit resistance value RSH is small, the short circuit current value ISH increases as shown in the above equation (1). When the short circuit current value ISH becomes excessive, a problem such as a failure of the circuit of the display driver 20 occurs. On the other hand, when the short circuit resistance value RSH is large, the short circuit current value ISH decreases as shown in the above equation (1), and the voltage VSM of the monitor signal SM increases as shown in FIG. 13.

When the voltage VSM of the monitor signal SM increases in this way, a comparison result indicating that the voltage VSM is higher than the reference voltage VR is output from the comparison circuit 50 of the inspection circuit 40. Accordingly, the determination circuit 56 erroneously determines that the comparison result of the comparison circuit 50 matches the expected value EV of the drive signal SD at a high level, the abnormality of the short circuit cannot be correctly detected, and the determination accuracy of the determination circuit 56 deteriorates.

FIG. 14 is a diagram showing a relationship between the short circuit resistance value RSH and the voltage VSM of the monitor signal SM according to the embodiment. FIG. 14 shows examples in which a constant current value ICS flowing through the drive transistors TRP and TRN is 1 μA and 10 μA. When the constant current value is set to ICS in this way, the voltage VSM of the monitor signal SM can be expressed by the following equation (2).

$$VSM = ICS \times ( RL 1 + RSH ) \qquad ( 2 )$$

In the comparative example in FIG. 8, when the short circuit resistance value RSH changes as shown in the above equation (1), the short circuit current value ISH changes. When the short circuit resistance value RSH is small, the short circuit current value ISH increases, and a problem such as a failure of the circuit due to an overcurrent occurs. When the short circuit resistance value RSH is large, the voltage VSM of the monitor signal SM increases as shown in FIG. 13, and a problem occurs in which the determination circuit 56 makes an erroneous determination.

On the other hand, in the embodiment, since the short circuit current value ISH is limited to the constant current value ICS even when the short circuit resistance value RSH is small, it is possible to prevent a failure of the circuit due to an overcurrent. In the embodiment, in the above equation (2), when the short circuit resistance value RSH increases, the voltage VSM of the monitor signal SM also increases. However, by adjusting the constant current value ICS, erroneous determination in the determination circuit 56 can be prevented, and the determination accuracy can be improved. That is, in FIG. 14, when the constant current value ICS is set to, for example, 1 μA, the voltage VSM of the monitor signal SM can be sufficiently reduced even if the short circuit resistance value RSH increases. Therefore, for example, when a short circuit occurs in the signal line L1 of the drive signal SD, even when the expected value of the drive signal SD is at a high level, the voltage VSM of the monitor signal SM can be made lower than the reference voltage VR in the comparison circuit 50. Therefore, it is possible to prevent occurrence of an erroneous determination that the comparison result of the comparison circuit 50 match the expected value EV of the drive signal SD at a high level even when the abnormality of the short circuit occurs.

In this way, in the embodiment, the constant current value ICS of the constant current flowing through the drive transistors TRP and TRN is variable. For example, the constant current value ICS can be made variable using a circuit having a configuration as shown in FIGS. 11 and 12 as the current setting circuits 65 and 66. Taking FIG. 14 as an example, the constant current value ICS can be set to 1 μA, 10 μA, or the like. In this way, as described with reference to FIG. 14, by adjusting the constant current value ICS, the determination accuracy, which is the detection accuracy of the inspection circuit 40, can be adjusted according to a situation of the short circuit resistance value RSH or the like.

The adjustment for making the constant current value variable can be achieved by, for example, storing information in a nonvolatile memory (not shown) or setting a fuse in a fuse circuit. For example, the constant current value is set to be written to the nonvolatile memory or the fuse circuit during manufacturing or inspection before shipment of the display driver 20 or the display device 10. Alternatively, the control circuit 100 of the display driver 20 may appropriately adjust the constant current value using the control signal. For example, the voltage of the monitor signal SM may be measured, and the control circuit 100 may adjust the constant current value based on a measurement result.

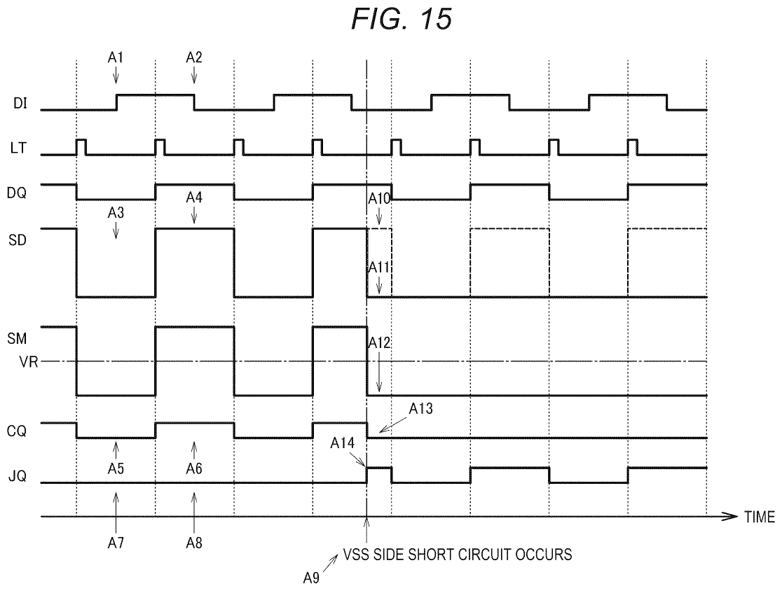

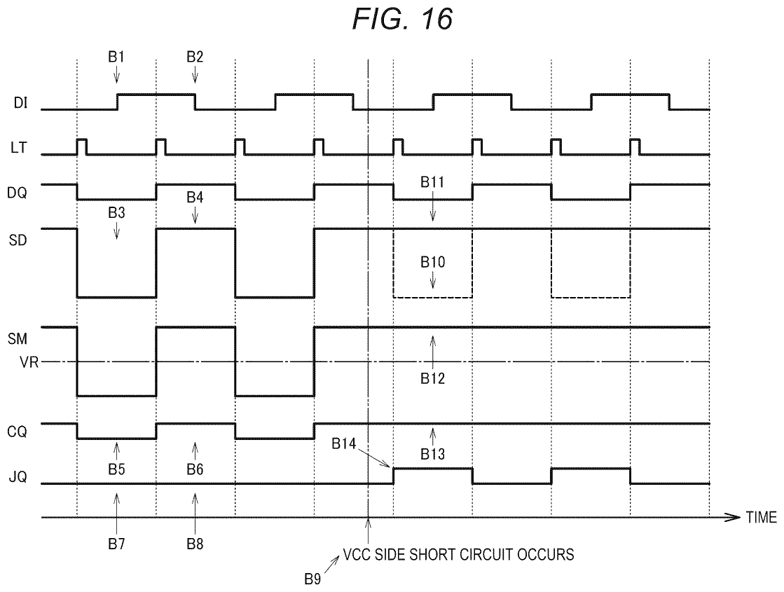

FIGS. 15 and 16 are signal waveform diagrams showing an operation of the display device 10 according to the embodiment. FIG. 15 shows an example of signal waveforms when a short circuit on the VSS side occurs as shown in FIG. 9, and FIG. 16 shows an example of signal waveforms when a short circuit on the VCC side occurs as shown in FIG. 10. Although the determination mode is actually set in, for example, an inspection period before a start of a normal operation after activation due to power-on or the like, the following description will be made assuming that the abnormality of the short circuit has occurred in the middle of the determination period set in the determination mode for simplification of the description.

As indicated by A1 and A2 in FIG. 15, the data DI for display is latched by the latch 72 in FIG. 5 and output to the driver circuit 30 as the data DO. Accordingly, as indicated by A3 and A4, the drive signal SD is output to the display electrode EL, and the monitor signal SM of the drive signal SD is input to the comparison circuit 50 of the inspection circuit 40.

That is, when the drive signal SD is at a low level as indicated by A3, the monitor signal SM is also at a low level, and when the drive signal SD is at a high level as indicated by A4, the monitor signal SM is also at a high level. In A5, since the voltage of the monitor signal SM is lower than the reference voltage VR (VRL), the signal CQ output by the comparison circuit 50 is at a low level. In A6, since the voltage of the monitor signal SM is higher than the reference voltage VR (VRH), the signal CQ is at a high level. In cases of A5 and A6, since the voltage level of the expected value EV corresponding to DQ matches the voltage level of the signal CQ, the signal JQ of the determination result of the determination circuit 56 is at a voltage level (for example, a low level) indicating that no abnormality has occurred, as indicated by A7 and A8.

In A9 in FIG. 15, a short circuit on the VSS side of the signal line L1 or the like occurs. When such a short circuit on the VSS side occurs, the voltage of the drive signal SD at a high level as indicated by A10 changes to a low level side as indicated by A11, and the voltage of the monitor signal SM also changes to the low level side as indicated by A12. Then, the comparison circuit 50 that compares the monitor signal SM changed to the low level side with the reference voltage VR outputs the signal CQ at a low level as indicated by A13. Therefore, since the high level which is the voltage level of the expected value EV of the drive signal SD does not match the low level which is the voltage level of the signal CQ, the signal JQ of the determination result of the determination circuit 56 is at a voltage level (for example, a high level) indicating that an abnormality has occurred as indicated by A14.

Next, FIG. 16, which shows an example of signal waveforms when a short circuit on the VCC side occurs, will be described. Since B1 to B8 in FIG. 16 are the same as A1 to A8 in FIG. 15, the description thereof will be omitted. In B9 in FIG. 16, a short circuit on the VCC side occurs in the signal line L1 or the like. When such a short circuit on the VCC side occurs, the voltage of the drive signal SD at a low level as indicated by B10 changes to a high level side as indicated by B11, and the voltage of the monitor signal SM also changes to the high level side as indicated by B12. Then, the comparison circuit 50 that compares the monitor signal SM changed to the high level side with the reference voltage VR outputs the signal CQ at a high level as indicated by B13. Therefore, since the low level which is the voltage level of the expected value EV of the drive signal SD does not match the high level which is the voltage level of the signal CQ, the signal JQ of the determination result of the determination circuit 56 is at a voltage level (for example, a high level) indicating that an abnormality has occurred as indicated by B14.

In this way, in the embodiment, when the comparison result of the comparison circuit 50 is not a comparison result corresponding to the expected value EV, the determination circuit 56 determines that an abnormality such as a short circuit of the signal line L1 of the drive signal SD has occurred. For example, in A13 and A14 in FIG. 15, since the low level which is the voltage level of the signal CQ serving as the comparison result of the comparison circuit 50 does not match the high level which is the voltage level of the expected value EV of the drive signal SD, the determination circuit 56 determines that an abnormality such as a short circuit has occurred. In B13 and B14, since the high level which is the voltage level of the signal CQ of the comparison circuit 50 does not match the low level which is the voltage level of the expected value EV of the drive signal SD, the determination circuit 56 determines that an abnormality such as a short circuit has occurred. In this way, the determination circuit 56 can determine whether an abnormality such as a short circuit of the signal line L1 of the drive signal SD has occurred only by determining whether the comparison result of the comparison circuit 50 matches the expected value EV corresponding to the voltage level of the drive signal SD. In the embodiment, even when a short circuit occurs in the signal line L1, the short circuit current is limited to the constant current, and thus it is possible to prevent a failure of the circuit due to an overcurrent. Since the constant current that does not depend on the short circuit resistance value flows, it is possible to prevent deterioration in the determination accuracy of the inspection circuit 40.

As described above, a display driver according to the embodiment includes a driver circuit that outputs a drive signal to a display electrode of an electro-optical panel, a driver control circuit that controls the driver circuit, and an inspection circuit. The inspection circuit includes a comparison circuit that compares a voltage of the drive signal with a reference voltage, and a determination circuit that determines an abnormality based on an expected value corresponding to a level of the drive signal and a comparison result of the comparison circuit. The driver control circuit controls a gate of a drive transistor of the driver circuit such that the drive transistor outputs the drive signal at a constant current in a determination mode.

According to the embodiment, the comparison circuit of the inspection circuit compares a voltage of a monitor signal of the drive signal with the reference voltage, and the determination circuit determines an abnormality such as a short circuit based on the expected value corresponding to a voltage level of the drive signal and a comparison result of the comparison circuit. Then, in the determination mode, the driver control circuit controls the gate such that the drive transistor of the driver circuit outputs the drive signal at the constant current. In this way, even when an abnormality such as a short circuit occurs in the signal line of the drive signal, it is possible to prevent an overcurrent from flowing through the drive transistor, or to prevent determination accuracy of the inspection circuit from deteriorating due to a voltage change of the monitor signal.

In the embodiment, the driver control circuit may include a constant current setting circuit that generates a gate voltage of the drive transistor for causing the drive transistor to output the drive signal at the constant current. The driver control circuit may include a switching circuit that outputs a display signal for causing the driver circuit to output the drive signal to the gate of the drive transistor in a normal operation mode, and that outputs the gate voltage from the constant current setting circuit to the gate of the drive transistor in the determination mode.

In this way, in the normal operation mode, the display signal is input to the gate of the drive transistor by the switching circuit, so that the driver circuit can output the drive signal based on the display signal. In the determination mode, the gate voltage from the constant current setting circuit is input to the gate of the drive transistor by the switching circuit, so that the driver circuit outputs the drive signal at the constant current.

In the embodiment, the driver circuit may include, as the drive transistor, a P-type drive transistor and an N-type drive transistor that are provided in series between a node of a power supply voltage on a high potential side and a node of a power supply voltage on a low potential side. The switching circuit may include a first switch circuit that outputs the display signal to a gate of the P-type drive transistor in the normal operation mode, and a second switch circuit that outputs the display signal to a gate of the N-type drive transistor in the normal operation mode.

In this way, in the normal operation mode, the display signal is input to the gate of the P-type drive transistor through the first switch circuit, and is input to the gate of the N-type drive transistor through the second switch circuit. Accordingly, the drive signal based on the display signal is output to the electro-optical panel, and a normal display operation is executed.

In the embodiment, the constant current setting circuit may include a first current setting circuit that includes a P-type transistor and a first current source provided in series between the node of the power supply voltage on the high potential side and the node of the power supply voltage on the low potential side and in which a gate and a drain of the P-type transistor are coupled to an output node. The constant current setting circuit may include a second current setting circuit that includes a second current source and an N-type transistor provided in series between the node of the power supply voltage on the high potential side and the node of the power supply voltage on the low potential side, and in which a gate and a drain of the N-type transistor are coupled to an output node. In the determination mode, the first switch circuit may couple the output node of the first current setting circuit and the gate of the P-type drive transistor, or the second switch circuit may couple the output node of the second current setting circuit and the gate of the N-type drive transistor.

In this way, by coupling the output node of the first current setting circuit and the gate of the P-type drive transistor, a current mirror circuit is implemented by the P-type transistor and the P-type drive transistor, and a constant current flows through the P-type drive transistor. By coupling the output node of the second current setting circuit and the gate of the N-type drive transistor, a current mirror circuit is implemented by the N-type transistor and the N-type drive transistor, and a constant current flows through the N-type drive transistor.

In the embodiment, the driver control circuit may pull down the gate of the N-type drive transistor when the output node of the first current setting circuit and the gate of the P-type drive transistor are coupled by the first switch circuit. The driver control circuit may pull up the gate of the P-type drive transistor when the output node of the second current setting circuit and the gate of the N-type drive transistor are coupled by the second switch circuit.

In this way, when the output node of the first current setting circuit and the gate of the P-type drive transistor are coupled, the gate of the N-type drive transistor is pulled down and turned off. When the output node of the second current setting circuit and the gate of the N-type drive transistor are coupled, the gate of the P-type drive transistor is pulled up and turned off.

In the embodiment, a constant current value of the constant current may be variable.

In this way, it is possible to appropriately adjust the determination accuracy in the inspection circuit by adjusting the constant current value.

In the embodiment, the determination circuit may determine that a short circuit of the signal line of the drive signal has occurred when the comparison result of the comparison circuit is not a comparison result corresponding to the expected value.

In this way, the determination circuit can determine occurrence of a short circuit only by determining whether the comparison result of the comparison circuit matches the expected value corresponding to the voltage level of the drive signal.

A display device according to the embodiment includes the display driver described above and the electro-optical panel.

While the embodiment has been described in detail above, a person skilled in the art can readily understand that many modifications can be made without substantially departing from the novel matters and effects of the present disclosure. Therefore, all such modifications are within the scope of the present disclosure. For example, a term described at least once together with a different term having a broader meaning or the same meaning in the specification or the drawings can be replaced with the different term at any part in the specification or the drawings. All combinations of the embodiment and the modifications are also included in the scope of the present disclosure. The configurations, operations, and the like of the display driver, the display device, and the like are not limited to those described in the embodiment, and various modifications can be made.

What is claimed is:

1. A display driver comprising:
a driver circuit configured to output a drive signal to a display electrode of an electro-optical panel;
a driver control circuit configured to control the driver circuit; and
an inspection circuit, wherein
the inspection circuit includes
a comparison circuit configured to compare a voltage of the drive signal with a reference voltage, and
a determination circuit configured to determine an abnormality based on an expected value corresponding to a level of the drive signal and a comparison result of the comparison circuit, and
the driver control circuit controls a gate of a drive transistor of the driver circuit such that the drive transistor outputs the drive signal at a constant current in a determination mode.

2. The display driver according to claim 1, wherein
the driver control circuit includes
a constant current setting circuit configured to generate a gate voltage of the drive transistor for causing the drive transistor to output the drive signal at the constant current, and
a switching circuit configured to output, to the gate of the drive transistor, a display signal for causing the driver circuit to output the drive signal in a normal operation mode, and to output the gate voltage from the constant current setting circuit to the gate of the drive transistor in the determination mode.

3. The display driver according to claim 2, wherein
the driver circuit includes, as the drive transistor, a P-type drive transistor and an N-type drive transistor that are provided in series between a node of a power supply voltage on a high potential side and a node of a power supply voltage on a low potential side, and
the switching circuit includes
a first switch circuit configured to output the display signal to a gate of the P-type drive transistor in the normal operation mode, and
a second switch circuit configured to output the display signal to a gate of the N-type drive transistor in the normal operation mode.

4. The display driver according to claim 3, wherein
the constant current setting circuit includes
a first current setting circuit that includes a P-type transistor and a first current source provided in series between the node of the power supply voltage on the high potential side and the node of the power supply voltage on the low potential side and in which a gate and a drain of the P-type transistor are coupled to an output node, and
a second current setting circuit that includes a second current source and an N-type transistor provided in series between the node of the power supply voltage on the high potential side and the node of the power supply voltage on the low potential side and in which a gate and a drain of the N-type transistor are coupled to an output node, and
in the determination mode, the first switch circuit couples the output node of the first current setting circuit and the gate of the P-type drive transistor, or the second switch circuit couples the output node of the second current setting circuit and the gate of the N-type drive transistor.

5. The display driver according to claim 4, wherein
the driver control circuit
pulls down the gate of the N-type drive transistor when the output node of the first current setting circuit and the gate of the P-type drive transistor are coupled by the first switch circuit, and
pulls up the gate of the P-type drive transistor when the output node of the second current setting circuit and the gate of the N-type drive transistor are coupled by the second switch circuit.

6. The display driver according to claim 1, wherein
a constant current value of the constant current is variable.

7. The display driver according to claim 1, wherein
the determination circuit determines that a short circuit of a signal line of the drive signal has occurred when the comparison result of the comparison circuit is not a comparison result corresponding to the expected value.

8. A display device comprising:
the display driver according to claim 1; and
the electro-optical panel.
